(19) United States
(12) Patent Application Publication
(10) Pub. No.: US 2018/0304310 A1
(43) Pub. Date: Oct. 25, 2018

(54) Interference Reduction Techniques in Haptic Systems

(71) Applicant: ULTRAHAPTICS IP LTD, Bristol (GB)

(72) Inventors: Benjamin John Oliver Long, Bristol (GB); Thomas Andrew Carter, Bristol (GB); David Philip Tester, Cambridge (GB)

(21) Appl. No.: 15/959,266

(22) Filed: Apr. 22, 2018

Related U.S. Application Data
(60) Provisional application No. 62/489,161, filed on Apr. 24, 2017.
(60) Provisional application No. 62/511,397, filed on May 26, 2017.

(51) Int. Cl. B06B 1/16; B06B 1/02; H04R 1/28; G06F 3/01

(52) U.S. Cl. CPC B06B 1/166; G06F 3/016; H04R 1/2869; B06B 1/0261

(57) ABSTRACT

As control points in haptic systems move around, the phase offsets for each transducer change at discrete points in time. These are each expressed as a phase offset combined with a monochromatic carrier frequency. To prevent sharp frequency changes, an algorithm that maintains smooth transitions is used. Further, non-idealities in the implementation of haptic array modulation can create spurs in the frequency response of audio output from the array. Adjusting the signal carrier frequency and the signal modulating frequency may substantially reduce audio noise via a notch filter centered at an interpolation frequency.

### RELATED APPLICATIONS

This application claims the benefit of the following two U.S. Provisional patent applications, all of which are incorporated by reference in their entirety:

1) Ser. No. 62/489,161, filed on Apr. 24, 2017; and

2) Ser. No. 62/511,397, filed on May 26, 2017.

### FIELD OF THE DISCLOSURE

The present disclosure relates generally to interference reduction techniques in haptic-based systems.

### BACKGROUND

A continuous distribution of sound energy, which will be referred to as an “acoustic field”, may be used for a range of applications including haptic feedback in mid-air.

By defining one or more control points in space, the acoustic field can be controlled. Each point can be assigned a value equating to a desired amplitude at the control point. A physical set of transducers can then be controlled to create an acoustic field exhibiting the desired amplitude at the control points.

Each transducer in the set is driven with a phase offset such that a focus is achieved at each control point. As the control points move around, the phase offsets for each transducer change at discrete points in time. These are each expressed as a phase offset combined with a monochromatic carrier frequency. This interpretation leads to a simple method of a signal generator that uses offsets on single cycles of the carrier to create the driving signal for the transducers. However, the simple implementation has several problems with sharp frequency changes, which are not well reproduced by the physical transducers. Further, the approach may produce additional audible noise due to the sharp changes in frequency and effective phase. A more sophisticated algorithm that alleviates these issues would therefore confer commercial advantage.

Further, haptic feedback can be created using arrays of ultrasonic transducers. Each transducer emits audio in a frequency band beyond the range of human hearing using a carrier frequency which is modulated with a signal frequency. The modulation is used to form constructive and destructive interference patterns in the audio energy emitted from the array. Variation of these interference patterns, over short periods of time, creates haptic feedback for the user.

The high frequency audio energy is emitted from the ultrasonic transducer array in response to mathematical algorithms realized through electrical circuits. The electronic circuits used to stimulate the ultrasonic transducers are capable of emitting electromagnetic energy at the carrier and modulation frequencies used to stimulate the ultrasonic transducer array.

An implementation of an ultrasonic haptic feedback control system could emit ultrasonic audio from an array of 256 transducers, each transducer emitting audio energy at a carrier frequency of 40 kHz with a 100 Hz modulation used to create the haptic feedback.

The array of ultrasonic transducers used to generate haptic feedback will emit audio energy due to modulation within the range 0 Hz to 40 kHz. Direct contribution and harmonic components from these modulation frequencies will fall within the 0 Hz to 20 kHz audio frequency band.

The problems with the existing approach are the following:

Existing electrical and audio equipment is typically developed with an implicit assumption that audio energy (typically in the range 30 kHz to 300 kHz) is absent from the surrounding environment. Attenuation of audio energy in the range 30 kHz to 300 kHz (in free space) is significant. But attenuation of electromagnetic energy in the range 30 kHz to 300 kHz (in free space) is negligible.

Audio interference may occur when ultrasonic haptic feedback equipment is co-located with other audio equipment or equipment containing audio functionality.

Electromagnetic interference may occur when ultrasonic haptic feedback equipment is co-located with other audio equipment or equipment containing audio functionality.

The recent development of ultrasonic haptic feedback equipment means existing electrical and audio equipment is susceptible to these interferences.

The power drawn from the power supply for the ultrasonic haptic array can reach several amps. Depending on the PSRR (power supply rejection ratio) of the other non-haptic equipment connected to the PSU (power supply unit) sub-system (or external PSU). the current drawn by the haptic array will modulate (via the power supply) all other circuits connected to the same power supply. The level of modulation depends on the PSRR of the other circuits.

Electrical modulation (through the power supply) will directly couple into all electrical equipment sharing the same power supply(s) as the haptic equipment.

Audio energy emitted in the band 0 Hz to 20 kHz will directly couple into the output of any audio signal processing (such as microphones).

Electromagnetic energy emitted will directly couple into all electrical circuits for surrounding equipment.

Described are techniques for the suppression and elimination of unwanted interference from ultrasonic haptic feedback arrays and for the co-existence of ultrasonic haptic feedback arrays with other electronic and audio products.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows a signal generated to exhibit unwanted fluctuations in duty cycle and frequency when a linear ramp in phase is applied.

FIG. 2 shows a graph demonstrating the effect of sampling on interference effects.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### I. Continuous Phase Manipulation for Dynamic Phased-Array Systems

A. Effects of C⁰ Continuity in Phase

The class C⁰ consists of all continuous functions. The haptic system, which may include a mid-air haptic system, may be updated by continuously introducing phase and amplitude changes to each transducer. These phase and amplitude changes are generated by interpolating system states, which are representations of the state of the full set of transducers. These interpolations may generate a newly defined delay and duty cycle measured in ticks of an output clock that is ticking at some multiple greater than twice the carrier frequency. This delay and duty cycle can be interpreted as a string of binary digits with a length of this multiple in which the signal is high or 1 for some quantity of these ticks and low or 0 for the remainder.

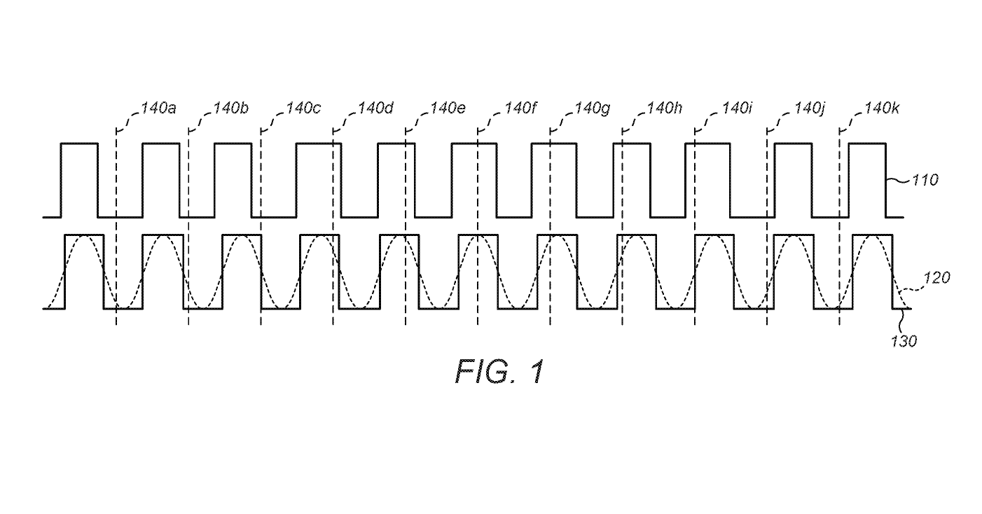

This approach is illustrated in FIG. 1 where a signal generated in this way is shown to exhibit unwanted fluctuations in duty cycle and frequency when a linear ramp in phase is applied. When the phase shifts linearly through time, the existing pulse width modulated (PWM) signal generation 110 result roughly matches the intended output but fluctuates in duty cycle and frequency. This can cause the output of a physical transducer to fluctuate due to differences in frequency response. The dashed lines 140a, 140b, 140c, 140d, 140e, 140f, 140g, 140h, 140i, 140j, 140k show the delineation between cycles of the carrier frequency in which the binary mask is computed. The lower signal 130 shows the ideal result superimposed upon the matching sine wave 120.

FIG. 1 further demonstrates that a frequency shift with an appropriate offset in angle produces a more acceptable version of the signal. This can be appreciated if by substituting a linear interpolation in phase, which can be described as:

$$θ = \frac{{t}_{1} - t}{{t}_{1} - {t}_{0}} {θ}_{0} + \frac{t - {t}_{0}}{{t}_{1} - {t}_{0}} {θ}_{1} ,$$

into an expression for a monochromatic wave, yielding

$$cos ( ω t - ( \frac{{t}_{1} - t}{{t}_{1} - {t}_{0}} {θ}_{0} + \frac{t - {t}_{0}}{{t}_{1} - {t}_{0}} {θ}_{1} ) ) ,$$

which can then be simplilted into:

$$cos ( ( ω - \frac{{θ}_{1} - {θ}_{0}}{{t}_{1} - {t}_{0}} ) t + \frac{{t}_{0} {θ}_{1} - {t}_{1} {θ}_{0}}{{t}_{1} - {t}_{0}} ) .$$

This can be then produced in the new frequency with the new phase offset to create a more consistent output signal. This benefit is contingent on having a PWM generator that can create an instantaneously variable frequency.

B. Effects of C¹ Continuity in Phase

The class C¹ consists of all differentiable functions whose derivative is continuous A further modification can be made to generate phase offset change with C¹ continuity. In the obvious case, four phase offsets equally separated in time are used to construct a cubic Hermite spline interpolation. However, the seemingly obvious approach yields properties that are undesirable.

1. Canonical Uniform Catmull-Rom Cubic Hermite Spline

Considering the canonical uniform Catmull-Rom cubic Hermite spline interpolation yields the phase angle as:

θ=(2t³−3t²+1)θ₀+(t³−2t²+t)(½θ₁−½θ₋₁)+(−2t³+3t²)θ₁+(t³−t²)(½θ₂−½θ₀),

which can be rewritten as:

A=ωt−θ

A=(½θ₋₁−3/2θ₀+3/2θ₁−½θ₂)t³+(−θ₋₁+5/2θ₀−2θ₁+½θ₂)t²+(ω+½θ₋₁−½θ₁)t−θ₀,

solving for ω′ and θ′ in:

cos(ω′(t)t+θ′(t))=cos(A)

yields:

ω′(t)=(½θ₋₁−3/2θ₀+3/2θ₁−½θ₂)t²+(−θ₋₁+5/2θ₀−2θ₁+½θ₂)t+(ω+½θ₋₁−½θ₁),

θ′(t)=−θ₀.

In this way, the C¹ continuity in phase angle across multiple intervals is assured. However, on top of C¹ continuity in phase angle, a further requirement should be that the effective frequency is required to be continuous. Substituting in the ends of the interval into the expression for frequency yields:

ω′(0)=ω+½θ₋₁−½θ₁,

ω′(1)=ω+θ₀−θ₁,

but then when the interval ends and the next interpolant begins:

ω+θ₋₁−θ₀≠ω+½θ₋₁−½θ₁.

This creates an unwanted discontinuity in frequency.

2. Uniform Catmull-Rom Cubic Hermite Spline with Backward Differencing

The system that requires that the derivatives on the interval must be constructed such that the substitution required to obtain the frequency yields a connected curve for frequency. In this way, the benefits of further smoothing the changes in phase with a cubic are added to the benefits of continuously changing frequency. If the frequency is changed continuously, then instantaneous output can be more effectively modeled. This has the potential for physically or electrically continuously tuned frequency responses for reasons of both efficiency and output power level.

This is achievable if the derivatives are constructed using a backward differencing scheme. In this case though, only three phase offsets equally separated in time are used. Under usual circumstances this would not be considered useful since a degree of freedom is sacrificed to obtain the desired continuous frequency property; in this scheme, there is no future point θ₂.

Considering the interpolant a second time yet with the central differencing scheme replaced by the backward differencing scheme (which is identical to the linearity in t that yields the frequency) gives the phase angle as:

θ=(2t³−3t²+1)θ₀+(t³−2t²+t)(θ₀−θ₋₁)+(−2t³+3t²)θ₁+(t³−t²)(θ₁−θ₀),

which can be rewritten as:

A=ωt−θ

A=(θ₋₁−2θ₀+θ₁)t³+(−2θ₋₁+4θ₀−2θ₁)t²+(ω+θ₋₁−θ₀)t−θ₀,

solving for ω′ and θ′ in:

cos(ω′(t)t+θ′(t))=cos(A)

yields:

ω′(t)=(θ₋₁−2θ₀+θ₁)t²+(−2θ₋₁+4θ₀−2θ₁)t+(ω+θ₋₁−θ₀),

θ′(t)=−θ₀.

Substituting in the ends of the interval into the expression for frequency yields:

ω′(0)=ω+θ₋₁−θ₀,

ω′(1)=ω+θ₀−θ₁,

Thus when the interval ends and the next interpolant begins:

ω+θ₋₁−θ₀≠ω+θ₋₁−θ₀.

This creates the desired continuous function in frequency.

### II. Interference Reduction for Ultrasonic Array

To solve interference issues, ultrasonic transducers are often “tuned” or optimized for operation at specific frequencies or frequency bands. Within these narrow frequency ranges the ultrasonic transducer efficiently converts electrical energy into audio energy, emitting audio energy at the excitation frequency. Modulation of the excitation frequency permits the generation of constructive interference patterns (or control points).

This system can be considered as a modulated carrier used to stimulate the ultrasonic transducer to generate audio energy with output audio phase and frequency depending on the input electrical signal. Spectrally, the output audio signal comprises two components: the carrier and the modulation.

Typically, the electrical stimulus for the ultrasonic transducer is a PWM (pulse width modulation) waveform whose phase and duty cycle on the input electrical signal define the phase, frequency and amplitude of the output audio signal. The modulation applied to the electrical input to the ultrasonic transducer generates a spectral output from the transducer array, where the modulation frequency applied to the array to generate the haptic feedback can be detected.

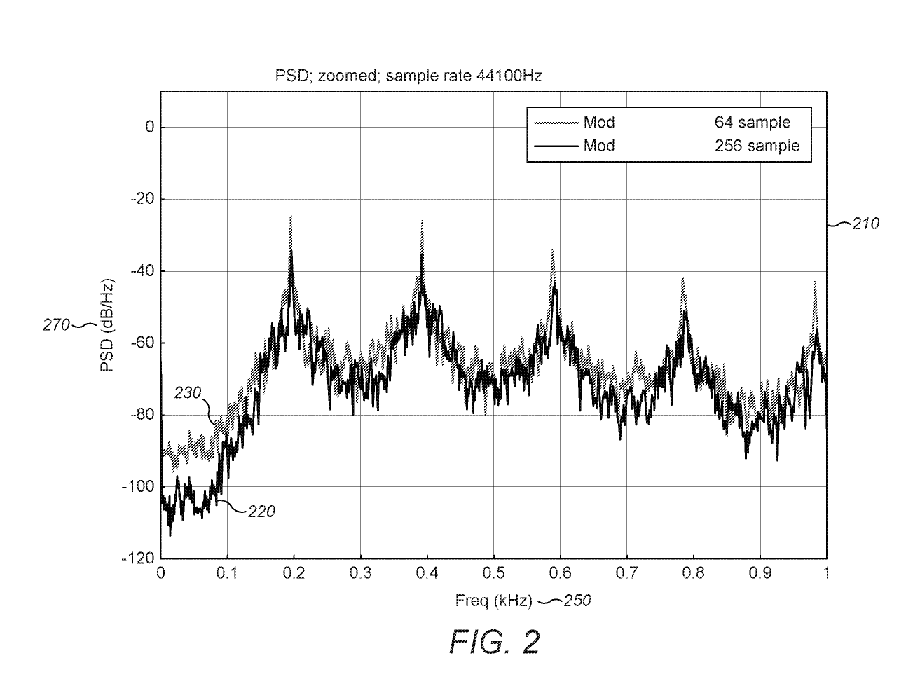

As an example, FIG. 2 shows a graph 210 with a y-axis 270 of power spectral density (PSD) in dB/Hz, an x-axis 250 of frequency in kHz. The light line 230 is modulated using 64 samples on the sine wave from peak to trough. The dark line 220 is modulated using 256 samples on the sine wave from peak to trough. The graph 210 shows that the 64-sample line 230 has a higher amount of noise than the 256-sample line 220 because the former line has fewer samples in its interpolation, leading it to be further away from a pure sine wave.

There are multiple concepts to provide solutions to this interference issues.

A. Concept 1: Notch Filters at the Modulation Frequency

Non-idealities in the implementation of the haptic array modulation scheme can create spurs in the frequency response of audio output from the array.

Two main forms of interference at the modulation frequency (of the haptic array) exist.

Electrically, since the haptic array may draw significant load current from the power supply, the load transient response of the power supply will couple the haptic array modulation onto the power supply.

Harmonics of the audio output (due to the sampled nature of the control point updates) will be present in the audio spectrum.

To eliminate coupling of audio artifacts from the haptic array to other equipment may be achieved with the addition of notch or band stop filter(s) with stopband centered at the interpolation frequency and optionally stopbands centered at harmonics of the interpolation frequency. The attenuation in the stopband(s) will act to suppress the interpolation harmonic artefacts and suppress/eliminate audio noise.

Similarly, to suppress electrical interference/modulation coupled through the power supply bandstop (or notch) filters could be introduced into the power supply network of other electrical circuits.

For systems with adjustable/configurable modulation schemes (i.e. adjustable interpolation rates) the center frequency for the stopband(s) could be configurable.

Alternatively, for systems with adjustable/configurable modulation schemes (i.e. adjustable interpolation rates) the bandwidth for the stopband(s) could be sufficiently wide to block the full range of frequency variation for the modulation scheme.

Addition of audio filtering for equipment operated close to/directly with haptic arrays could include digital filters within the audio path to implement band=−stop/band-rejection filters with near brickwall characteristics for the stop-band and allow centering of the stop-band(s) optimal for the modulation scheme used by the haptic array. Audio notch filters at the modulation frequency and harmonics of the modulation frequency.

B. Concept 2: Notch Filters at the Carrier Frequency

The ultrasonic transducers used to form the haptic feedback array are typically driven with electrical signals centered around a fixed carrier frequency (such as 40 kHz). The transducers convert the electrical energy at this frequency into output audio energy at the same frequency.

The implementation for the stimulus electrically driving the transducer (and algorithms) typically operate with a period equal to this PWM drive frequency or a sub-harmonic of the PWM drive frequency. Operation of the stimulus/algorithm circuits creates a repeating load on the power supply. If this power supply is shared with other equipment the carrier or PWM frequency modulates the operation of the additional shared equipment. Coupling of the haptic array electrical stimulus into the non-haptic, additional equipment occurs.

Similarly, to suppress electrical interference/modulation coupled through the power supply bandstop (or notch) filters could be introduced into the power supply network of other electrical circuits, as described in section II.A, above.

C. Concept 3: Haptic Equipment Advises Audio Equipment

When the haptic array transmits interference within the audio equipment, such interference will be generated by the haptic equipment. If the audio equipment is capable of suppressing the interference through modifications to the audio equipment operation, this can be enabled through a signal from the haptic equipment to the audio equipment.

D. Concept 4: Audio Equipment Advises Haptic Equipment

When the haptic array transmits interference within the audio equipment, such interference will be generated by the haptic equipment. If the audio equipment is not capable of suppressing the interference through modifications to the audio equipment operation the interference can be avoided by the audio equipment advising the haptic equipment that it must stop operation (and the haptic equipment stops emission during this time).

E. Concept 5: Reconfigure Audio Signal Processing

If the audio equipment has a bandwidth wider than the bandwidth of human hearing and so processes audio frequencies beyond the range of human hearing and if the signal processing chain of the audio equipment contains automatic gain control (AGC) loops, it is possible the AGC gain level(s) will be set based on the >20 kHz audio content from the haptic array.

Addition of 20 kHz low pass filtering (or stop band filtering, see above) into the audio signal path used for the AGC loop setting would avoid gain distortion to the <20 kHz audio signal from the >20 kHz audio generated from the haptic array.

If the audio signal chain already includes filtering but after gain stages then reversing the order so the gain stage(s) are after the filtering stage(s) will also reduce/eliminate interference from the haptic array to the audio equipment.

In summary, the embodiments include the following:

1. The concept of a 40 kHz notch filter in the RF path (and the audio path) of a cellphone (or other consumer electronics) to mitigate the interference from the transducer array.

2. The concept of a general purpose filter with a plurality of stop bands, each band being configurable (or fixed) for equipment coexisting with other equipment which emits ultrasonic audio output.

### III. Conclusion

While the foregoing descriptions disclose specific values of voltage, capacitance and current, any other specific values may be used to achieve similar results. Further, the various features of the foregoing embodiments may be selected and combined to produce numerous variations of improved haptic systems.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
i) producing an acoustic field from a transducer array, the transducer array comprising a plurality of transducers having known relative positions and orientations, wherein each of the plurality of transducers outputs a signal having a signal frequency and a signal effective phase;
ii) defining a plurality of control points, wherein each of the plurality of control points has a known spatial relationship relative to the transducer array; and
iii) adjusting the signal frequency and the signal effective phase to substantially reduce audible noise.

2. The method as in claim 1, wherein the plurality of transducers are a plurality of ultrasonic transducers.

3. The method as in claim 2, wherein the acoustic field is a mid-air acoustic field and wherein the plurality of control points are a plurality of control points in mid-air.

4. The method as in claim 3, wherein adjusting the signal frequency and the signal effective phase includes interpolating system states.

5. The method as in claim 4, wherein adjusting the signal frequency and the signal effective phase also includes the use of a pulse width modulated signal.

6. The method as in claim 3, wherein adjusting the signal frequency and the signal effective phase includes continuously changing the signal frequency.

7. The method as in claim 6, wherein adjusting the signal frequency and the signal effective phase also includes using a backward differencing scheme.

8. A method comprising:
i) producing an acoustic field from a transducer array, the transducer array comprising a plurality of transducers having known relative positions and orientations, wherein each of the plurality of transducers outputs a signal having a signal carrier frequency and a signal modulating frequency;
ii) defining a plurality of control points, wherein each of the plurality of control points has a known spatial relationship relative to the transducer array; and
iii) adjusting the signal carrier frequency and the signal modulating frequency to substantially reduce audible noise.

9. The method as in claim 8, wherein the plurality of transducers are a plurality of ultrasonic transducers.

10. The method as in claim 9, wherein the acoustic field is a mid-air acoustic field and wherein the plurality of control points are a plurality of control points in mid-air.

11. The method as in claim 10, wherein adjusting the signal carrier frequency and the signal modulating frequency to substantially reduce audible noise includes a notch filter centered at an interpolation frequency.

12. The method as in claim 11, wherein the notch filter is also centered at harmonics of the interpolation frequency.

13. A method comprising:
i) producing an acoustic field from a transducer array, the transducer array comprising a plurality of transducers having known relative positions and orientations;
ii) defining a plurality of control points, wherein each of the plurality of control points has a known spatial relationship relative to the transducer array; and
iii) adjusting signals external to the transducer array to substantially reduce audible noise.

14. The method as in claim 13, wherein the plurality of transducers are a plurality of ultrasonic transducers.

15. The method as in claim 14, wherein the acoustic field is a mid-air acoustic field and wherein the plurality of control points are a plurality of control points in mid-air.

16. The method as in claim 15, wherein adjusting signals external to the transducer array uses a plurality of stop bands, wherein each of the plurality of stop bands are configured to diminish interference between the signals external to the transducer array and signals of the transducer array.
